(19) United States
(12) Patent Application Publication
(10) Pub. No.: US 2008/0116039 A1
(43) Pub. Date: May 22, 2008

(54) Material regulating devices and material delivery systems having those devices

(75) Inventor: David Allen Ainsworth, Vancouver (CA)

Correspondence Address: KOLISCH HARTWELL, P.C., 520 SW YAMHILL STREET, Suite 200, PORTLAND, OR, 97204, US

(73) Assignee: Ainsworth Lumber Co., Ltd.

(21) Appl. No.: 11/604,101

(22) Filed: Nov. 22, 2006

(51) Int. Cl. B65G 33/02

(52) U.S. Cl. 198/657

(57) ABSTRACT

A material regulating device and a method of regulating wood pieces are disclosed. In some embodiments, the material regulating device may include a base assembly, a housing, an inclining assembly configured to selectively move the housing relative to the base assembly, and a conveying assembly configured to move material pieces toward a discharge outlet and to allow a portion of the material pieces to move back toward a feed inlet such that at least approximately a specified amount of material pieces exits the discharge outlet. In some embodiments, the method includes receiving an unregulated amount of wood pieces, moving at least some of the wood pieces towards a discharge outlet, and allowing a portion of the at least some of the wood pieces to move back toward a feed inlet such that at least approximately a specified amount of wood pieces exits the discharge outlet.

### BACKGROUND OF THE DISCLOSURE

Various manufacturing processes may require receiving an unregulated amount of material pieces and regulating that amount to provide a specified amount of material pieces. For example, in the manufacturing processes for engineered wood products, an unregulated amount of wood pieces (such as wood flakes and/or wood strands) may be regulated to provide a specified amount of wood pieces. Those wood pieces may then be arranged in particular configuration(s) to form a blanket of wood pieces. The blanket may then be exposed to elevated temperatures, elevated pressures, and/or radiant energy to form engineered wood products. Various material regulating devices may be used to receive an unregulated amount of material pieces, such as wood pieces, and to regulate that amount to provide a specified amount of material pieces.

### SUMMARY OF THE DISCLOSURE

Some embodiments provide a material regulating device. The material regulating device may include a base assembly; a housing movably connected to the base assembly, the housing having a feed inlet and a discharge outlet, the feed inlet configured to receive an unregulated amount of material pieces, wherein the housing and the base assembly define an inclination angle; an inclining assembly configured to selectively move the housing relative to the base assembly to change the inclination angle; and a conveying assembly at least partially contained within the housing and configured to move at least some of the material pieces toward the discharge outlet and to allow a portion of the at least some of the material pieces to move back toward the feed inlet as the at least some of the material pieces move toward the discharge outlet such that at least approximately a specified amount of material pieces exits the discharge outlet, wherein the portion of the at least some of the material pieces that move back toward the feed inlet is responsive, at least in part, to the inclination angle.

Some embodiments provide a material regulating device. The material regulating device may include a base assembly; a housing pivotally connected to the base assembly, the housing having a feed inlet and a discharge outlet, the feed inlet configured to receive an unregulated amount of wood pieces, wherein the housing and the base assembly define an inclination angle; an inclining assembly configured to selectively pivot the housing relative to the base assembly to change the inclination angle; and a plurality of screw conveyors that are at least partially contained within the housing and are configured to move at least some of the wood pieces toward the discharge outlet and to allow a portion of the at least some of the wood pieces to move back toward the feed inlet as the at least some of the wood pieces move toward the discharge outlet such that at least approximately a specified amount of wood pieces exits the discharge outlet, wherein the portion of the at least some of the wood pieces that move back toward the feed inlet is responsive, at least in part, to the inclination angle.

Some embodiments provide a material regulating device. The material regulating device may include a base assembly; a housing pivotally connected to the base assembly, the housing having a feed inlet and a discharge outlet, the feed inlet configured to receive an unregulated amount of wood pieces, wherein the housing and the base assembly define an inclination angle; means for selectively pivoting the housing relative to the base assembly to change the inclination angle; and means for moving at least some of the wood pieces toward the discharge outlet and for allowing a portion of the at least some of the wood pieces to move back toward the feed inlet as the at least some of the wood pieces move toward the discharge outlet such that at least approximately a specified amount of wood pieces exits the discharge outlet, wherein the portion of the at least some of the wood pieces that move back toward the feed inlet is responsive, at least in part, to the inclination angle.

Some embodiments provide a method of regulating wood pieces. The method may include receiving an unregulated amount of wood pieces at a feed inlet of a housing; moving at least some of the wood pieces toward a discharge outlet of the housing; and allowing a portion of the at least some of the wood pieces that are moving toward the discharge outlet to move back toward the feed inlet such that at least approximately a specified amount of wood pieces exits the discharge outlet.

### BRIEF DESCRIPTION OF THE DRAWINGS

FIG. 1 is a schematic view of some embodiments of a material regulating device.

FIG. 2 is a side view of an illustrative example of the material regulating device of FIG. 1.

FIG. 3 is a top view of the material regulating device of FIG. 2.

FIG. 4 is a bottom view of a housing and a conveying assembly of the material regulating device of FIG. 2.

FIG. 5 is a cross-sectional view of the material regulating device of FIG. 2 taken along lines 5-5 shown in FIG. 3.

FIG. 6 is a schematic view of some embodiments of a material delivery system having a material regulating device of FIG. 1.

FIG. 7 is a partial view of an illustrative example of the material delivery system of FIG. 6.

FIG. 8 is a flowchart showing some embodiments of a method of regulating material pieces.

### DETAILED DESCRIPTION OF THE DISCLOSURE

FIG. 1 depicts some embodiments of a material regulating device 10. The material regulating device may include any suitable structure configured to receive an unregulated amount U of material pieces and to regulate that amount to provide a specified amount S of material pieces.

“Specified amount,” as used herein regarding the material pieces, refers to an amount of material pieces that is needed and/or requested by one or more pieces of equipment downstream of the material regulating device and/or that is requested by one or more users. The amount may be based on any suitable property or properties of the material pieces, such as mass, weight, length, width, thickness, volume, and/or number of pieces. Alternatively, or additionally, the amount may be based on any suitable property or properties of the material pieces on a per unit time basis, such as weight per minute and/or volume per second.

“Unregulated amount,” as used herein regarding material pieces, refers to an amount of material pieces that is provided to the material regulating device without regard to the specified amount of material pieces. The unregulated amount of material pieces may be more, equal, or less than the specified amount of material pieces. Additionally, or alternatively, unregulated amount U may be random, uncontrolled, and/or unanticipated in its delivery to the material regulating device.

“Material pieces,” as used herein, refers to any suitable pieces, such as wood pieces, coal pieces, metal pieces (such as taconite pieces), rock pieces, etc. Additionally, the material pieces may contain any suitable amount of fluid(s). For example, the material pieces may include wet wood pieces and/or dry wood pieces. Additionally, or alternatively, the material pieces may be in the form of semi-solids, such as sludges. Moreover, the material pieces may include any suitable shapes, such as elongate, spherical, semi-spherical, cubical, semi-cubical, cylindrical, semi-cylindrical, and/or any suitable combination. Although particular material pieces are discussed, the material pieces may include any suitable pieces, which may have any suitable fluid content and/or any suitable shape(s).

“Wood pieces,” as used herein regarding material pieces, refers to flakes, strands, veneers, pieces, fines, and/or any suitable pieces sliced or otherwise cut from wood raw material(s), such as logs. The wood pieces may be any suitable size(s). For example, when the wood pieces include flakes, then those flakes may have lengths (y-dimension) of up to about 12 inches or about 4.5 inches to about 6.0 inches, and may have widths (x-dimension) of up to about 12 inches or about 1.5 inches to about 2.5 inches. Similarly, those flakes may have a thickness (z-dimension) of about 0.001 inches to about 0.060 inches, or about 0.020 inches to about 0.030 inches. The width of the flakes may be a function of the length of the flakes. For example, the length of the flakes may be at least about three times greater than the width of the flakes, which may provide for proper flake orientation and acceptable physical properties for the engineered wood product.

Alternatively, or additionally, when the wood pieces include strands, then those strands may have lengths (y-dimension). of about 6 inches or about 0.5 inches to about 7 inches, and may have widths (x-dimension) of about 1 inch or about 0.04 inches to about 2.5 inches. Similarly, those strands may have a thickness (z-dimension) of about 0.031 inches, or about 0.01 inches to about 0.08 inches. The width of the strands may be a function of the length of the strands. For example, the length of the strands may be at least about three times to at least about six times greater than the width of the flakes. Although the wood pieces are described to have certain dimension ranges, those wood pieces may have any suitable dimensions.

Material regulating device 10 may include a base assembly 12, a bed or housing 14, an inclining assembly 16, and a conveying assembly 18, as shown in FIG. 1. The base assembly may include any suitable structure configured to at least partially support other components of the material regulating device.

Housing 14 may include any suitable structure movably connected to the base assembly and/or configured to at least partially contain conveying assembly 18. The housing may be pivotably, slidingly, and/or movably connected in other suitable ways to the base assembly such that the housing may be moved relative to base assembly 12. In some embodiments, the housing may be inclined relative to the base assembly such that the housing and the base assembly may define an inclination angle I, as shown in FIG. 1. The inclination angle also may be referred to as an angle of elevation.

The housing may include a feed inlet 20 and a discharge outlet 22. The feed inlet may be configured to receive unregulated amount U of material pieces. Discharge outlet 22 may be configured to discharge specified amount S of material pieces. Additionally, housing 14 may include one or more containment portions 24, which may include any suitable structure configured to at least partially contain material pieces. The containment portions may be adjacent to the conveying assembly and/or may be at least substantially free from flat surfaces. In some embodiments, the lack of flat surfaces may facilitate the flow of material pieces and/or prevent the accumulation of the material pieces between the feed inlet and the discharge outlet (may be referred to as “hang up” or “jamming” spots).

Although housing 14 is shown to be movably connected to base assembly 12, conveying assembly 18 may alternatively, or additionally, be movably connected to the base assembly. Additionally, although inclination angle I is shown to be defined by base assembly 12 and housing 14, the inclination angle may be defined by base assembly 12 and conveyor assembly 18. Moreover, although housing 14 is shown to include a single feed inlet and a single discharge outlet, the housing may include any suitable number of feed inlets and/or discharge outlets.

Furthermore, although housing 14 is shown to have feed inlet 20 and discharge outlet 22 at particular locations, the feed inlet and the discharge outlet may be in any suitable locations of the housing. Additionally, although housing 14 is discussed to have containment portions 24 that are at least substantially free from flat surfaces, the housing may have any suitable type(s) of containment portions, including containment portions with at least some flat surfaces.

Inclining assembly 16 may be operatively connected to housing 14 and may include any suitable structure configured to selectively move housing 14 relative to base assembly 12 to change inclination angle I. For example, the inclining assembly may be configured to move the housing relative to the base assembly between a first inclination angle and a second inclination angle. The first and second inclination angles may be any suitable angles, such as 30 degrees and 60 degrees, respectively. In some embodiments where housing 14 is pivotally connected to base assembly 12, the inclining assembly may be configured to pivot the housing relative to the base assembly.

Inclining assembly 16 may additionally, or alternatively, be configured to automatically move the housing to a particular inclination angle responsive, at least in part, to any suitable factors and/or process parameters. Those factors and/or parameters may include specified amount S, unregulated amount U, type(s) of the material pieces, fluid content of the material pieces, operating temperature, operating pressure, and/or other suitable parameters.

Although inclining assembly 16 is shown to be operatively connected to housing 14, the inclining assembly may alternatively, or additionally, be operatively connected to one or more other components of the material regulating device. For example, inclining assembly 16 may alternatively, or additionally, be operatively connected to conveying assembly 18. Additionally, although inclining assembly 16 is shown to be configured to move housing 14 relative to base assembly 12, the inclining assembly may alternatively, or additionally, be configured to selectively move one or more other components of the material regulating device. For example, inclining assembly 16 may alternatively, or additionally, be configured to selectively move conveying assembly 18 relative to the base assembly and/or the housing.

Conveying assembly 18 may be at least partially contained within housing 14 and may include any suitable structure configured to move at least some of the material pieces from feed inlet 20 toward discharge outlet 22. In some embodiments, the conveying assembly may be further configured to move the at least some of the material pieces from feed inlet 20 toward the discharge outlet at a rate responsive, at least in part, to the specified amount of material pieces.

Additionally, the conveying assembly may include any suitable structure configured to allow one or more return portions T of the material pieces that are being moved toward the discharge outlet to move back toward feed inlet 20, as shown in FIG. 1. In some embodiments, movement of material pieces toward discharge outlet 22 and movement of the return portions back toward feed inlet 20 may ensure that at least approximately the specified amount of material pieces exits the discharge outlet. In those embodiments, one or more of the return portions may be referred to as including excess and/or unrequired material pieces because those pieces may not be necessary to provide at least approximately the specified amount of material pieces at the discharge outlet.

The return portions of the material pieces may move back toward the feed inlet responsive, at least in part, to the inclination angle because of, for example, gravitational forces. At least some of return portions T may move fully back to the feed inlet and then move again toward discharge outlet 22, at least some of return portions T may move partly back toward the feed inlet and then move again toward the discharge outlet, and/or any suitable combination. At least some of return portions T may contact any suitable portion(s) of the housing as the portions move back toward feed inlet 20.

Although return portions T are shown as two streams in FIG. 1, the return portions may be in any suitable number of streams, which may move fully back and/or move partly back toward the feed inlet. Additionally, although return portions T are shown to contact housing 14 as it moves back toward the feed inlet, at least some of the return portion may move fully and/or partly back toward the feed inlet within the. conveying assembly.

Material regulating device 10 also may include a control device 26, which may include any suitable structure operatively connected to inclining assembly 16, conveying assembly 18, and/or other components of the material regulating device and configured to control inclination angle I, the rate, and/or other parameter(s) of the material regulating device responsive, at least in part, to the specified amount of material pieces. In some embodiments, the control device also may be operatively connected to material measuring equipment (further discussed below) that may measure how much of the specified amount of the material pieces has already been delivered by the material regulating device.

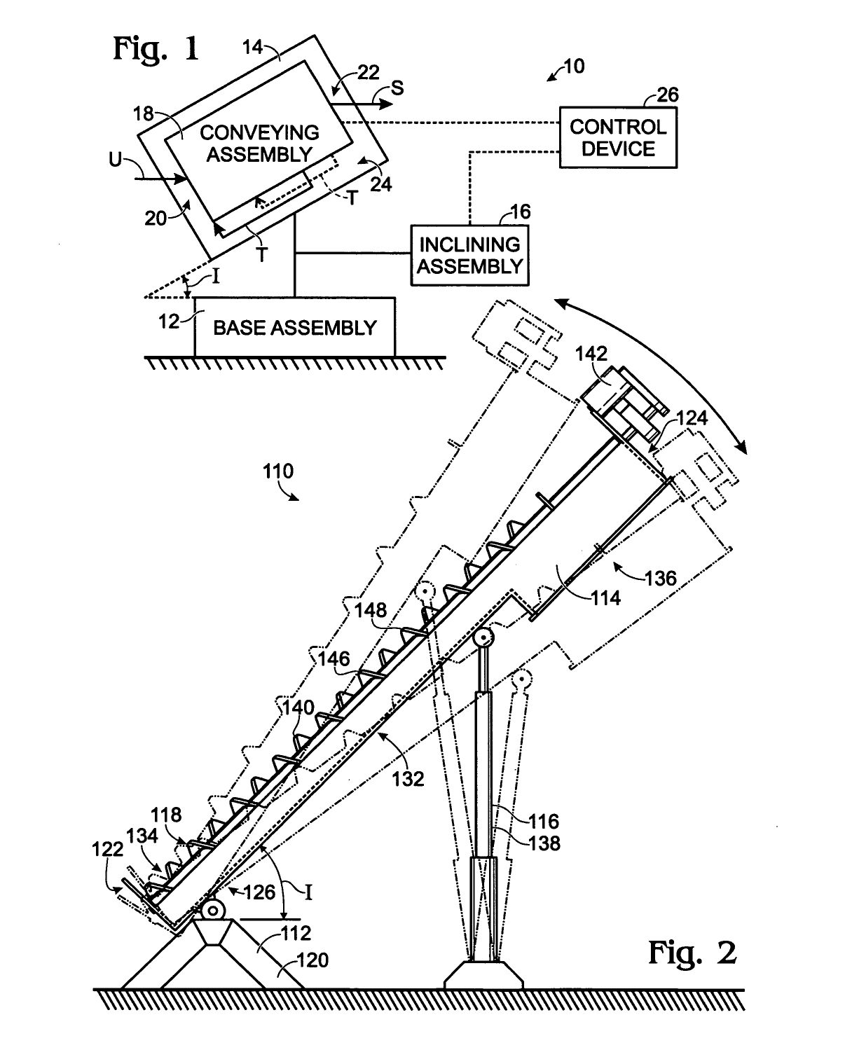

An illustrative example of material regulating device 10 is shown in FIGS. 2-5 and is generally indicated at 110. Unless otherwise indicated, material regulating device 110 may have at least some of the components of material regulating device 10 discussed above. Material regulating device 110 may include a base assembly 112, a housing 114, an inclining assembly 116, and a conveying assembly 118, as shown in FIGS. 2-5.

The base assembly may include a stand 120, as shown in FIG. 2. Although stand 120 is shown with a particular structure, the stand may include any suitable structure configured to at least partially support the other components of material regulating device 110.

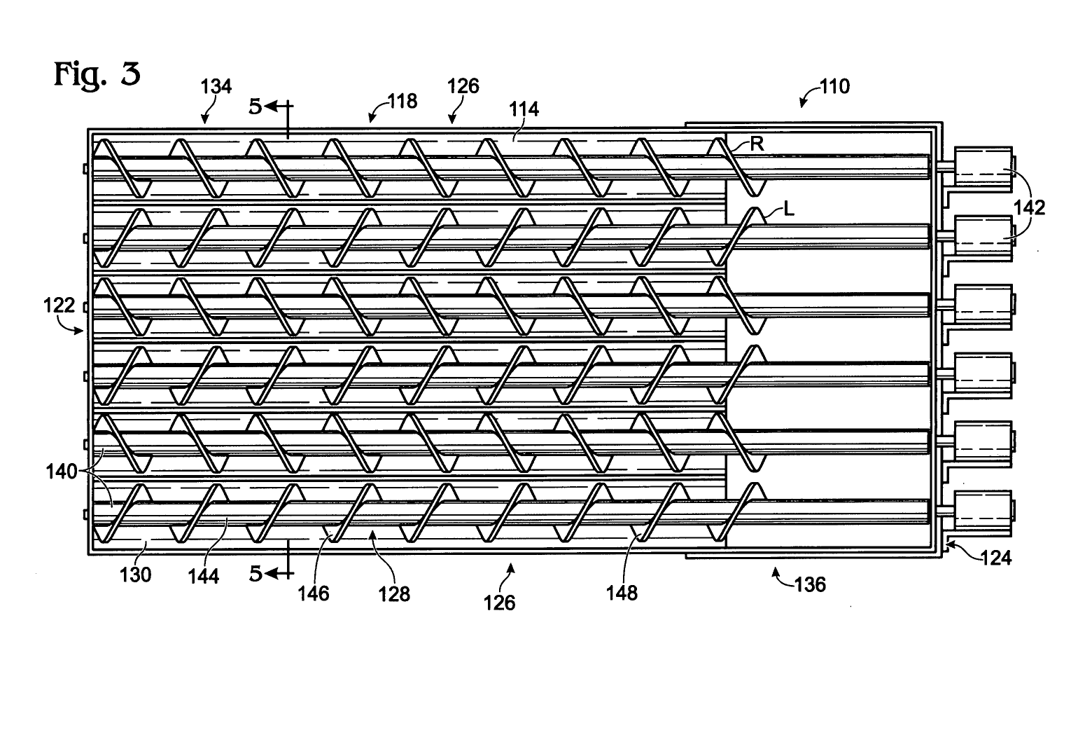

Housing 114 may be pivotally connected to stand 120 such that the housing may be inclined relative to the base assembly. The housing and the base assembly may define an inclination angle I, as shown in FIG. 2. Housing 114 may include at least one front portion 122, at least one back portion 124, side portions 126, and at least one bottom portion 128, as shown in FIGS. 2-3. Front portion 122 may be sized to at least substantially receive the unregulated amount of material pieces, while back portion 124 may be sized to support one or more motors of the conveying assembly.

Side portions 126 and bottom portion 128 may be any suitable size(s) and/or shape(s) configured to at least substantially contain material pieces. At least part of side portions 126 and at least part of bottom portion 128 also may be referred to as containment portion 132 of the housing. Additionally, side portions 126 and/or bottom portion 128 may be configured to facilitate the flow of material pieces and/or prevent the accumulation of the material pieces between the feed inlet and the discharge outlet. For example, side portions 126 and bottom portion 128 may include one or more halfpipes 130. The halfpipes may have any suitable radius or radii. For example, halfpipes 130 may have a radius such that side portions 126 and/or bottom portion 128 that the material pieces may contact may be at least substantially free from flat surfaces. In some embodiments, at least a portion of the conveyor assembly may be contained within at least some of the halfpipes.

Housing 114 may alternatively, or additionally, include a feed inlet 134 and a discharge outlet 136, as shown in FIG. 2. The feed inlet is configured to receive at least a substantial portion of the unregulated amount of the material pieces, while discharge outlet is configured to discharge at least approximately the specified amount of the material pieces. In some embodiments, front portion 122, proximal parts of the side portions, and a proximal part of the bottom portion may be referred to as the feed inlet, while back portion 124, distal parts of the side portions, and a distal part of the bottom portion may be referred to as the discharge outlet.

Although housing 114 is shown to be pivotally connected to stand 120, the housing may alternatively, or additionally, be connected to the stand in other suitable ways, such as slidingly and/or rotatingly connected to the stand. Additionally, although inclination angle I is shown to be defined by bottom portion 128 of housing 114 and a top surface of stand 120, the inclination angle may be defined by any suitable portion(s) of the housing and the stand.

Moreover, although housing 114 is shown without a top portion, the housing may include one or more top portions. Furthermore, although side portions 126 and bottom portion 128 are shown to include halfpipes 130, those portions may include any suitable structure configured to facilitate the flow of material pieces and/or prevent the accumulation of the material pieces between the feed inlet and the discharge outlet. For example, side portions 126 and bottom portion 128 may include corrugated and/or ribbed structures.

Inclining assembly 116 may include at least one telescoping cylinder 138, as shown in FIG. 2. The telescoping cylinder may be operatively connected to the housing and configured to move the housing relative to the base assembly among a plurality of positions. For example, the telescoping cylinder may move the housing relative to the base assembly between a first inclination angle and a second inclination angle. The first and second inclination angles may be any suitable angles, such as 30 degrees and 60 degrees, respectively. The telescoping cylinder may be connected to any suitable hydraulic system (not shown) and/or other drive system configured to selectively move telescoping cylinder 138.

The inclining assembly may be operatively connected to and/or selectively controlled by a control device (not shown) to control the inclination angle. The control device may control the inclination angle, a rate of movement of the conveyor assembly, and/or other parameter(s) of the material regulating device responsive, at least in part, to the specified amount of material pieces.

Although inclining assembly 116 is shown to include at least one telescoping cylinder 138, the inclining assembly may include any suitable structure configured to move the housing relative to the base assembly among a plurality of positions. For example, inclining assembly 116 may include radial swinging cylinders, rotary hydraulic cylinders, rotary pneumatic cylinders, servo motors, and/or rotary turntable systems. Additionally, although telescoping cylinder 138 is shown to move the housing relative to the base assembly between inclination angles of 30 to 60 degrees, the telescoping cylinder may alternatively, or additionally, be configured to move the housing to inclination angles lower than 30 degrees and/or higher than 60 degrees. Moreover, although inclining assembly 116 is shown to be configured to move the housing relative to the base assembly, the inclining assembly may alternatively, or additionally, be configured to move at least a portion of the conveying assembly.

Conveying assembly 118 may include a plurality of augers or screw conveyors 140 and one or more motors 142, as shown in FIGS. 2-5. The screw conveyors may be sized to be at least partially contained within halfpipes 130, as shown in FIG. 5. Any suitable number of screw conveyors 140 may be used, such as six screw conveyors. At least some of the screw conveyors may be located adjacent to each other. Although approximately half of screw conveyors 140 are shown to be contained within halfpipes 130, any suitable portion(s) of the screw conveyors may be contained within halfpipes 130.

At least some of screw conveyors 140 may include a shaft portion 144 and at least one threaded portion 146. The shaft portion may be rotated by the at least one motor. The threaded portion may be attached to or incorporated with the shaft portion and may include any suitable structure configured to move at least some of material pieces toward discharge outlet 136. For example, threaded portion 146 may include blades 148, as shown in FIGS. 2-5. The blades also may be referred to as threads and/or flutes.

The blades may be any suitable shape(s). and/or size(s). For example, blades 148 may include one or more helical shapes. In some embodiments, helical shaped blades may minimize damage to material pieces. Blades 148 also may have any suitable orientation(s). For example, at least some of the screw conveyors may have blades 148 that have left-handed or clockwise orientations L such that clockwise rotation of the shaft portions of those conveyors would move material pieces from feed inlet 134 to discharge outlet 136. Additionally, or alternatively, at least some of the screw conveyors may have blades 148 that have right-handed or counter-clockwise orientations R such that counter-clockwise rotation of the shaft portions of those conveyors would move material pieces from feed inlet 134 to discharge outlet 136. In some embodiments, the screw conveyors may have alternating blade orientations, such as the screw conveyors shown in FIGS. 3-5.

Although blades 148 are shown to include a continuous helical shape, the blades may include any suitable shape(s), which may be discrete or continuous. In some embodiments, the shape(s) of the blades may be configured to move more or less material pieces toward the discharge outlet and/or to allow more or less material pieces back toward the feed inlet. Additionally, although blades 148 are shown to be solid blades, the blades may include any suitable structure configured to allow more material pieces to move back toward the feed inlet. For example, blades 148 may include one or more perforations.

Moreover, although screw conveyors 140 are shown to have alternating blade orientations, the screw conveyors may have any suitable type of blade orientations. For example, two or three adjacent screw conveyors may have at least one type of blade orientation, while another two or three adjacent screw conveyors may have at least another type of blade orientation. Alternatively, most or all of the screw conveyors may have a single type of blade orientation.

Motors 142 may be supported by housing 114 (such as by back portion 124) and may include any suitable structure configured to selectively rotate the shaft portion of one or more of the screw conveyors. For example, the motors may include a variable frequency drive (VFD) system.

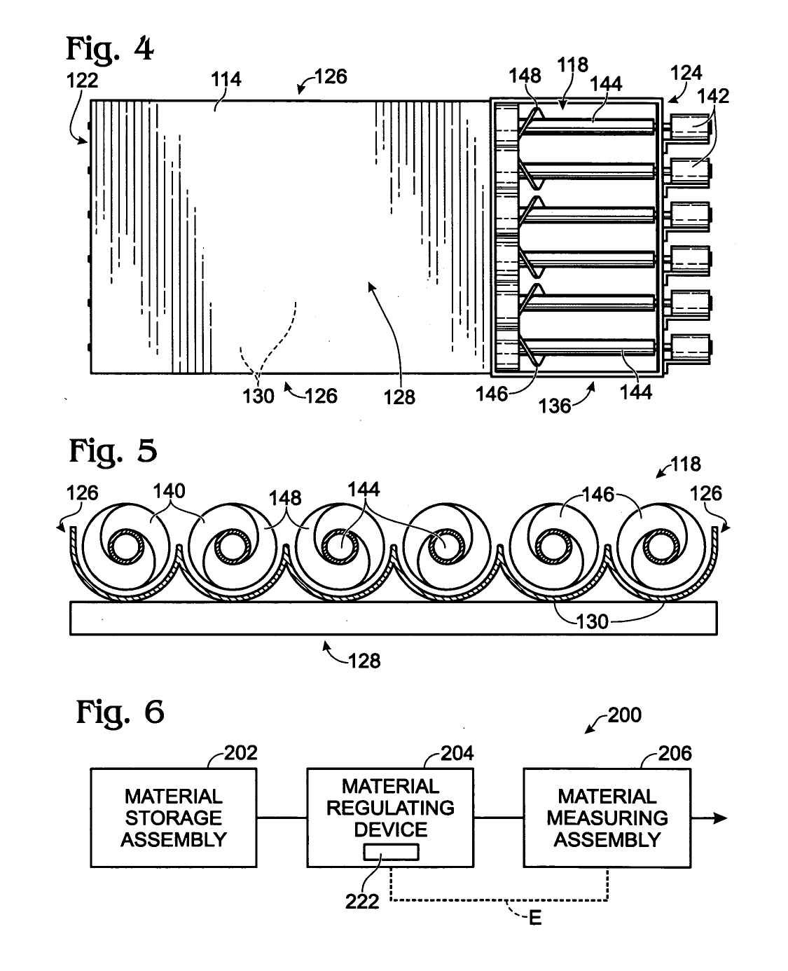

Each screw conveyor 140 may include a motor, such as shown in FIGS. 3-4. The motors may be configured to selectively rotate the shaft portion of the screw conveyors in any suitable directions, such as clockwise and/or counter-clockwise directions. For example, at least a first motor may be configured to rotate one or more screw conveyors at least in a first direction, and at least a second motor may be configured to rotate one or more other screw conveyors in at least a second direction. The first direction may be the same as the second direction or may be different from the second direction.

In some embodiments, the motor of at least some of the screw conveyors may be configured to rotate in one or more directions that correspond to the orientation of the blades of that screw conveyor. For example, a screw conveyor with blades having a clockwise orientation may have an associated motor configured to rotate the screw conveyor in the clockwise direction. Additionally, or alternatively, a screw conveyor with blades having a counter-clockwise orientation may have an associated motor configured to rotate the screw conveyor in the counter-clockwise direction.

Although motors 142 are shown to rotate the screw conveyors in alternating directions, the motors may rotate the screw conveyors in any suitable direction or combination of directions. For example, two or three adjacent motors may rotate their associated screw conveyors in at least one direction, while another two or three adjacent motors may rotate their associated screw conveyors in at least another direction. Alternatively, most or all of the motors may rotate their associated screw conveyors in a single direction. Additionally, although motors 142 are shown to rotate the screw conveyors in directions corresponding to the blade orientation of the screw conveyors, the motors may be configured to rotate the screw conveyors in other direction(s) that do not correspond to the blade orientation of those conveyors.

Motors 142 may be operatively connected to and/or selectively controlled by a control device (not shown) to control a rate of movement (such as a rate of rotation) of the shaft portion of the screw conveyors. The control device may control the rate of movement, the inclination angle, and/or other parameter(s) of the material regulating device responsive, at least in part, to the specified amount of material pieces.

Although screw conveyors 140 are shown to be driven by motors 142, the screw conveyors may be driven by any suitable structure, such as via one or more hydraulic systems and/or by any structure that may allow for speed, rate, and/or direction of rotation adjustment while the speed conveyors are in operation. Additionally, although each screw conveyor 140 is shown to have an associated motor 142, any suitable number of motors may be used to drive the screw conveyors. In some embodiments, the number of motors may be less than the number of screw conveyors. In those embodiments, conveying assembly 118 may include a transmission assembly (not shown) may be used to drive the shaft portions of the screw conveyors. For example, a single motor and a transmission assembly may be used to drive the shaft portion of at least some of the screw conveyors. The transmission assembly may include gears, belts, chains, and/or any other suitable components.

Moreover, although conveying assembly 118 is shown to include screw conveyors 140, the conveying assembly may include any suitable structure configured to move at least some of the material pieces toward the discharge outlet and/or to allow a portion of those pieces to move back toward the feed inlet as the material pieces are moving toward the discharge outlet. For example, the conveying assembly may alternatively, or additionally, include rake conveyors, escalator conveyors, bed conveyors, roller conveyors, chain conveyors, mesh conveyors, slat conveyors, and/or other suitable conveyors.

In operation, a specified amount of material may be determined and/or inputted to the control device. The control device may request upstream equipment for material pieces, which may be an unregulated amount of material pieces. The feed inlet of the housing may then receive an unregulated amount of the material pieces from the upstream equipment (also may be referred to as “flood feeding” the material regulating device). The conveying assembly may move at least some of the material pieces toward the discharge outlet. The conveying assembly also may allow a portion of the material pieces to move back toward the feed inlet as the material pieces are moved toward the discharge outlet, where the portion of the material pieces that moves back toward the feed inlet may be responsive, at least in part, to the inclination angle between the housing and the base assembly.

The control device may control the rate of movement of the material pieces toward the discharge outlet, the inclination angle to adjust the portion of the material pieces that moves back toward the feed inlet, and/or other parameter(s) responsive, at least in part, to the specified amount of material pieces. The control device may shut off the conveying assembly when at least approximately the specified amount of material pieces is delivered to downstream equipment. However, the steps discussed above may be performed in different sequences and in different combinations, not all steps being required for all embodiments of the material regulating device.

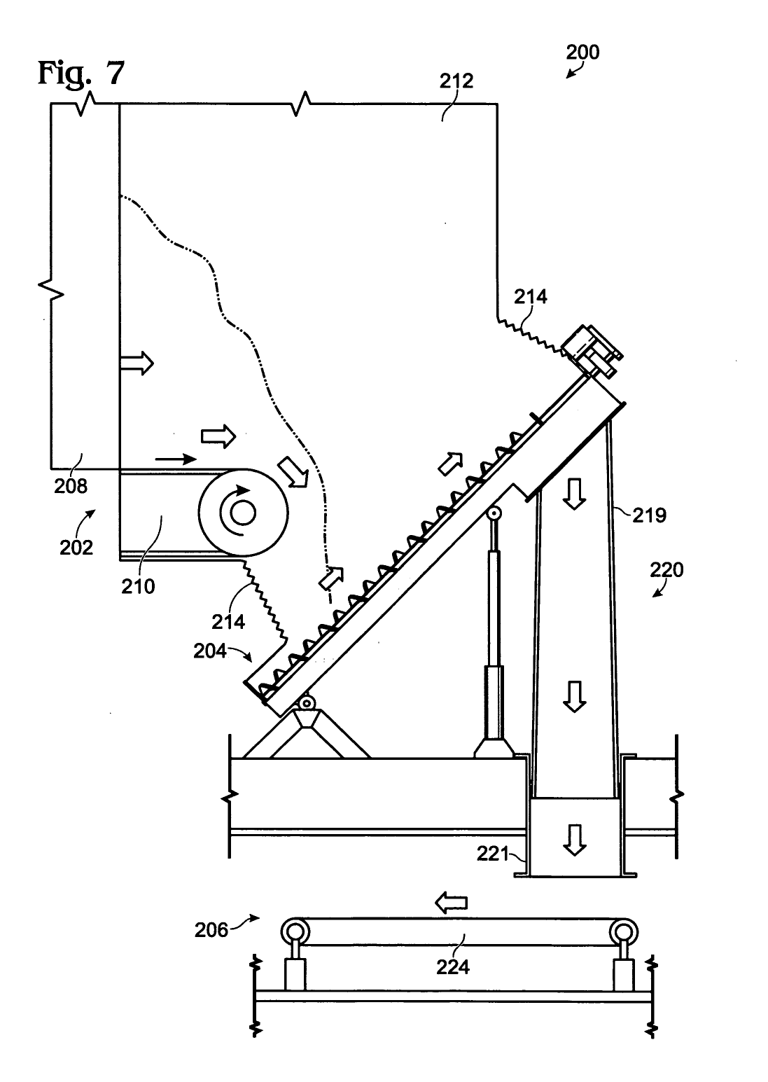

FIGS. 6-7 depict some embodiments of a material delivery system 200, which may include any suitable structure configured to deliver material pieces to downstream equipment. For example, the material delivery system may include a material storage assembly 202, a material regulating device 204, and a material measuring assembly 206. Material storage assembly 202 may include any suitable structure configured to store and/or deliver material pieces to the material regulating device. For example, material storage assembly 202 may include at least one storage bin or container 208 and at least one feed conveyor 210. The feed conveyor may deliver an unregulated amount of material pieces to the material regulating device from storage container 208.

The material storage assembly also may include a shroud 212 and one or more containment walls 214, as shown in FIG. 7. The shroud and/or containment walls may be configured to at least substantially contain the material pieces. Containment walls 214 may be expandable and/or retractable such that those walls may move with the housing of the material regulating device.

Although material storage assembly 202 is shown to include a single container and a single feed conveyor, the storage assembly may include any suitable number of storage containers and/or feed conveyors. Additionally, although feed conveyor 210 is shown to include a belt conveyor, the feed conveyor may alternatively, or additionally, be any suitable type(s) of conveyor, such as the conveyors discussed above.

Material regulating device 204 may include at least some of the components of the material regulating devices discussed above. Additionally, the material regulating device may include a containment chute 220, which may include any suitable structure connected to or adjacent to the discharge outlet of the material regulating device and configured to at least substantially contain material pieces from the discharge outlet and/or to direct those pieces to the material measuring assembly. In some embodiments, at least a portion of the containment chute may move with the material regulating device, such as when the housing is inclined relative to the base assembly.

For example, the containment chute may include a first portion 219 and a second portion 221. First portion 219 may be connected to or adjacent to the discharge outlet of the material regulating device and may be at least partially received within second portion 221. The second portion may receive the first portion and extend towards the material measuring assembly. In some embodiments, first portion 219 may be referred to as a sleeve portion, while second portion 221 may be referred to as a straight portion.

Although a particular containment chute is shown, any suitable chute may be used. For example, one or more chutes with one or more bellows may alternatively, or additionally, be used. Additionally, although material regulating device 204 is shown to include a containment chute 220, the material regulating device may include any suitable structure to direct at least a substantial portion of the material pieces to the material measuring assembly.

Material regulating device 204 also may include a control device 222, which may be operatively connected to the inclining assembly, the conveying assembly, and/or other components of the material regulating device to control the rate, the inclination angle, and/or other parameter(s) responsive, at least in part, to the specified amount of material pieces. The control device also may be operatively connected to the material measuring assembly to selectively adjust the rate, the inclination angle, and/or other process parameter(s) based on measurements made by the material measuring assembly.

Material measuring assembly 206 may include any suitable structure configured to measure the material pieces that exits the discharge outlet of the material regulating device and/or to provide measurement information E to the control device of the material regulating device. The material measuring assembly may measure any suitable property or properties of the material pieces, such as weight, volume, etc. For example, the material measuring assembly may include a weigh conveyor 224, as shown in FIG. 7.

The weigh conveyor may be configured to weigh material pieces from the material regulating device and/or to transport those material pieces to downstream equipment. Although material measuring assembly 206 is shown to include a weigh conveyor, the material measuring assembly may include any suitable structure configured to measure the material pieces that exits the discharge outlet of the material regulating device and/or to provide measurement information to the control device of the material regulating device.

In operation, a specified amount of material pieces may be determined and/or inputted by the control device of the material regulating device. The control device may request material storage assembly to deliver material pieces, which may be an unregulated amount of material pieces, to the material regulating device. The feed conveyor may deliver the unregulated amount of material pieces from the storage container to the material regulating device. The material regulating device may provide the material pieces to the weight conveyor of the material measuring assembly. The weight conveyor then delivers the material pieces to downstream equipment. The control device may shutoff the conveying assembly of the material regulating device when the weight conveyor determines that at least approximately the specified amount of material pieces has been delivered. However, the steps discussed above may be performed in different sequences and in different combinations, not all steps being required for all embodiments of the material delivery system.

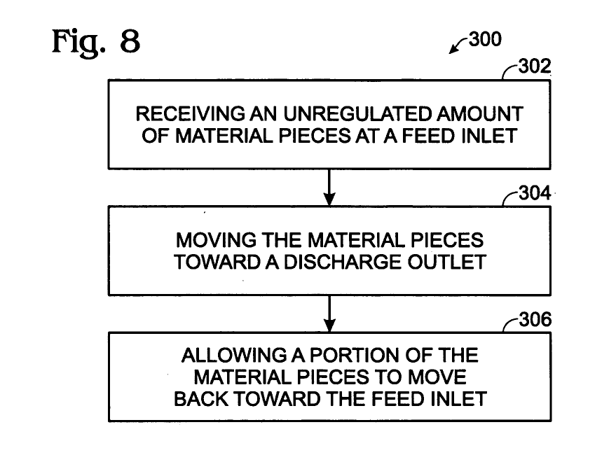

FIG. 8 depicts some embodiments of a method 300 of regulating material pieces, such as wood pieces. The method may include receiving an unregulated amount of material pieces at the feed inlet portion of a housing at 302. At least some of those material pieces may then be moved toward a discharge outlet of the housing at 304. That movement may include controlling a rate of movement of the material pieces toward the discharge outlet.

While the material pieces are moved toward the discharge outlet, a portion of the material pieces may be allowed to move back toward the feed inlet at 306, such that at least approximately a specified amount of material pieces exits the discharge outlet. The material pieces may be allowed to move back toward the feed inlet by, for example, controlling an inclination of the housing relative to a base assembly to allow the portion of the material pieces to move back toward the feed inlet. However, the steps discussed above may be performed in different sequences and in different combinations, not all steps being required for all embodiments of the method of regulating material pieces.

Although material regulating devices, material delivery systems, and methods of regulating material pieces, and features of the material regulating devices, material delivery systems, and methods of regulating material pieces have been shown and described with reference to the foregoing operational principles and preferred embodiments, those skilled in the art will find apparent that various changes in form and detail may be made without departing from the spirit and scope of the claims. The present disclosure is intended to embrace all such alternatives, modifications, and variances that fall within the scope of the appended claims.

What is claimed is:

1. A material regulating device, comprising:
a base assembly;
a housing movably connected to the base assembly, the housing having a feed inlet and a discharge outlet, the feed inlet configured to receive an unregulated amount of material pieces, wherein the housing and the base assembly define an inclination angle;
an inclining assembly configured to selectively move the housing relative to the base assembly to change the inclination angle; and
a conveying assembly at least partially contained within the housing and configured to move at least some of the material pieces toward the discharge outlet and to allow a portion of the at least some of the material pieces to move back toward the feed inlet as the at least some of the material pieces move toward the discharge outlet such that at least approximately a specified amount of material pieces exits the discharge outlet, wherein the portion of the at least some of the material pieces that move back toward the feed inlet is responsive, at least in part, to the inclination angle.

2. The material regulating device of claim 1, wherein the conveying assembly includes at least one screw conveyor.

3. The material regulating device of claim 2, wherein the at least one screw conveyor includes a first screw conveyor configured to rotate in a first direction, and a second screw conveyor configured to rotate in a second direction.

4. The material regulating device of claim 3, wherein the first direction is the same as the second direction.

5. The material regulating device of claim 3, wherein the first direction is different from the second direction.

6. The material regulating device of claim 3, wherein the first screw conveyor is located adjacent the second screw conveyor.

7. The material regulating device of claim 1, wherein the inclining assembly is configured to move the housing relative to the base assembly between a first inclination angle and a second inclination angle responsive, at least in part, to the specified amount of material pieces.

8. The material regulating device of claim 7, wherein the first inclination angle is 30 degrees.

9. The material regulating device of claim 7, wherein the second inclination angle is 60 degrees.

10. The material regulating device of claim 1, wherein the housing is pivotally connected to the base assembly, and the inclining assembly is configured to pivot the housing relative to the base assembly.

11. The material regulating device of claim 1, wherein the housing includes a containment portion adjacent the conveying assembly and the containment portion is at least substantially free from flat surfaces.

12. The material regulating device of claim 11, wherein the containment portion includes one or more halfpipes.

13. The material regulating device of claim 1, wherein at least a portion of the material pieces that move back toward the feed inlet contacts the housing.

14. The material regulating device of claim 1, wherein the conveying assembly is further configured to move the at least some of the material pieces toward the discharge outlet at a rate responsive, at least in part, to the specified amount of material pieces.

15. The material regulating device of claim 14, further comprising a control device operatively connected to the conveying assembly and the inclining assembly and configured to control at least one of the rate and the inclination angle responsive, at least in part, to the specified amount of material pieces.

16. The material regulating device of claim 1, wherein the material pieces include wood pieces.

17. The material regulating device of claim 16, wherein the wood pieces include wood flakes.

18. The material regulating device of claim 16, wherein the wood pieces include wood strands.

19. A material regulating device, comprising:
a base assembly;
a housing pivotally connected to the base assembly, the housing having a feed inlet and a discharge outlet, the feed inlet configured to receive an unregulated amount of wood pieces, wherein the housing and the base assembly define an inclination angle;
an inclining assembly configured to selectively pivot the housing relative to the base assembly to change the inclination angle; and
a plurality of screw conveyors that are at least partially contained within the housing and are configured to move at least some of the wood pieces toward the discharge outlet and to allow a portion of the at least some of the wood pieces to move back toward the feed inlet as the at least some of the wood pieces move toward the discharge outlet such that at least approximately a specified amount of wood pieces exits the discharge outlet, wherein the portion of the at least some of the wood pieces that move back toward the feed inlet is responsive, at least in part, to the inclination angle.

20. The material regulating device of claim 19, wherein the plurality of screw conveyors includes a first screw conveyor configured to rotate in a first direction, and a second screw conveyor adjacent to the first screw conveyor and configured to rotate in a second direction.

21. The material regulating device of claim 19, wherein the plurality of screw conveyors are further configured to move the at least some of the wood pieces toward the discharge outlet at a rate responsive, at least in part, to the specified amount of wood pieces.

22. The material regulating device of claim 21, further comprising a control device operatively connected to the plurality of screw conveyors and the inclining assembly and configured to control at least one of the rate and the inclination angle responsive, at least in part, to the specified amount of wood pieces.

23. The material regulating device of claim 21, further comprising a control device operatively connected to the plurality of screw conveyors and the inclining assembly and configured to control the rate and the inclination angle responsive, at least in part, to the specified amount of material pieces.

24. The material regulating device of claim 19, wherein the wood pieces include at least one of wood flakes and wood strands.

25. The material regulating device of claim 19, wherein the housing include a plurality of halfpipes.

26. The material regulating device of claim 25, wherein at least some of the screw conveyors is at least partially contained within at least some of the halfpipes.

27. A material regulating device, comprising:
a base assembly;
a housing pivotally connected to the base assembly, the housing having a feed inlet and a discharge outlet, the feed inlet configured to receive an unregulated amount of wood pieces, wherein the housing and the base assembly define an inclination angle;
means for selectively pivoting the housing relative to the base assembly to change the inclination angle; and
means for moving at least some of the wood pieces toward the discharge outlet and for allowing a portion of the at least some of the wood pieces to move back toward the feed inlet as the at least some of the wood pieces move toward the discharge outlet such that at least approximately a specified amount of wood pieces exits the discharge outlet, wherein the portion of the at least some of the wood pieces that move back toward the feed inlet is responsive, at least in part, to the inclination angle.

28. The material regulating device of claim 27, further comprising a means for controlling at least one of a rate of movement of the at least some of the wood pieces toward the discharge outlet and the inclination angle responsive, at least in part, to the specified amount of material pieces.

29. A method of regulating wood pieces, comprising:
receiving an unregulated amount of wood pieces at a feed inlet of a housing;
moving at least some of the wood pieces toward a discharge outlet of the housing; and
allowing a portion of the at least some of the wood pieces that are moving toward the discharge outlet to move back toward the feed inlet such that at least approximately a specified amount of wood pieces exits the discharge outlet.

30. The method of regulating wood pieces of claim 29, wherein allowing a portion of the at least some of the wood pieces that are moving toward the discharge outlet to move back toward the feed inlet includes controlling an inclination of the housing relative to a base assembly to allow the portion of the at least some of the wood pieces that are moving toward the discharge outlet to move back toward the feed inlet.

31. The method of regulating wood pieces of claim 29, wherein moving at least some of the wood pieces toward a discharge outlet of the housing includes controlling a rate of movement of the wood pieces toward the discharge outlet.

32. The method of regulating wood pieces of claim 29, wherein the wood pieces include at least one of wood flakes and wood strands.
